(19) United States
(12) Patent Application Publication
(10) Pub. No.: US 2008/0259046 A1
(43) Pub. Date: Oct. 23, 2008

(54) Pressure sensitive touch pad with virtual programmable buttons for launching utility applications

(76) Inventor: Joseph Carsanaro, Chapel Hill, NC (US)

Correspondence Address: Ober, Kaler, Grimes & Shriver;Attorneys at Law, 120 East Baltimore Street, Baltimore, MD, 21202-1643, US

(21) Appl. No.: 12/080,819

(22) Filed: Apr. 4, 2008

Related U.S. Application Data
(60) Provisional application No. 60/922,046, filed on Apr. 5, 2007.

(51) Int. Cl. G06F 3/041

(52) U.S. Cl. 345/173

(57) ABSTRACT

A pressure sensitive Display Pad having embedded dual functionality such as operating as a mouse for pointer navigation and an array of Virtual Programmable Applications Buttons for selection on the computing device and displaying applications such as a calculator, currency converter, daily event calendar, etc. The device is an improvement to existing resistive and capacitive touch pads that eliminates the need for additional dedicated mechanical buttons for launching utility applications. An exemplary embodiment is disclosed in the context of a laptop computer wherein the Display Pad performs the pointing and selection functions of existing laptop touchpads, and additionally provides for fixed or programmable pressure sensitive application functions using virtual buttons on the touchpad which can launch utility applications associated with those buttons, either on the computer screen or on the Display Pad display or both.

### CROSS-REFERENCE TO RELATED APPLICATION(S)

The present application derives priority from U.S. provisional application Ser. No. 60/922,046 filed 5 Apr. 2007.

### BACKGROUND OF THE INVENTION

1. Field of the Invention

The present invention relates to electronic devices having input devices in the form of a pressure sensitive displays or touch pads.

2. Description of Prior Art

Capacitive and resistive displays known as “touchpads” are commonly used in the consumer electronics industry as a means of pointing and selecting application functions.

For example, SmartPhone touchscreen displays utilize resistive technology as a means of interacting with the SmartPhone functions. Likewise, many personal audio MP3 players utilize capacitive touch pads to operate the MP3 Player. Laptops also utilize capacitive touch pads as a means for pointing and selecting and thereby creating user-interaction. These touchscreens and touchpads have been deployed in a number of products in recent years.

Existing solutions in this field have a number of limitations. One main limitation is that they tend to have limited functionality and require supplemental mechanical keys to operate multiple functions.

For example, SmartPhones tend to include a number of dedicated mechanical keys to switch between applications. While SmartPhones deploy a resistive or capacitive touch screen, they require the use of mechanical keys to navigate from the email application, to the phone application, to the calendar, etc. The same is true of laptops that have capacitive touchpads as they also include right select and left select keys for pointer selection and activation of additional menu options, and dedicated function buttons such as Quick Launch mechanical buttons or dedicated purpose buttons all on a separate part of the laptop such as a keypad to launch specific applications.

It would be more efficient to provide a pressure sensitive touch pad with Virtual Programmable Applications Buttons for launching Utility Applications.

### SUMMARY OF THE INVENTION

It is therefore the primary object of the present invention to provide a pressure sensitive Display Pad separate and apart from the primary computer display, for example, resident where a mouse pad would normally reside with Virtual Programmable Applications Buttons for launching Utility Applications.

It is another object to provide a pressure sensitive Display Pad with Virtual Programmable Applications Buttons that reduce or eliminate the need for mechanical buttons.

It is another object to provide a pressure sensitive touch pad with Virtual Programmable Applications Buttons that fixed or programmable functionality for application assignment flexibility and non-mechanical customization.

It is still another object to provide a pressure sensitive Display Pad with Virtual Programmable Applications Buttons that provide feedback audible and/or tactile upon accepted selection of a command.

It is yet another object to provide a pressure sensitive Display Pad with Virtual Programmable Applications Buttons displayed with, or in association with graphic content or aesthetics such as a screen saver, slideshow, or entertainment including a game or video clip.

It is another object to provide a pressure sensitive Display Pad with Virtual Programmable Applications Buttons having embedded dual functionality such as operating as a mouse for pointer navigation and selection on the computing device while simultaneously providing productivity and displaying applications such as a calculator, currency converter, daily event calendar, etc.

In accordance with the foregoing objects, the present system and apparatus is an improvement to existing resistive and capacitive touch pads that eliminates the need for additional dedicated mechanical buttons for launching utility applications.

An exemplary embodiment is disclosed in the context of a pressure sensitive Display Pad with virtual programmable buttons for operating a laptop computer. The Display Pad performs the pointing and selection functions of existing laptop touchpads, and additionally provides for fixed or programmable pressure sensitive application functions using virtual buttons on the touchpad which can launch utility applications associated with those buttons, either on the computer screen or on the Display Pad display or both. These fixed virtual buttons may have optional feedback tactile and/or audible as well as visual upon accepted selection of a command.

The fixed or programmable Virtual Application Keys are fully programmable for application assignment flexibility or non-mechanical customization, and they additionally provide aesthetics such as a screen saver or slideshow, entertainment with a game or video clip, or productivity with applications like a calculator, currency converter, or daily event calendar while at the same time operating as a mouse for pointer navigation and selection on the computing device.

Specifically, the pressure sensitive Display Pad superposes virtual programmable buttons overtop or segregates them from a display area for viewing multifunctional applications. This is much easier and more convenient than leaving the main computer application displayed on the laptop display and searching with the mouse in the computer menu system for a calculator, for instance. The applications initiated from the virtual programmable buttons on the Display Pad can be run on the primary computer display, the Display Pad display, or both. The Display Pad may be powered by its own resident power source a battery, or may derive power from the power bus of the computing device. The programmable force sensitive Display Pad is therefore also a way to reduce the energy consumption of the computing device by eliminating the need for powering up the main display for all applications.

The touch pad preferably includes an extended area that has fixed-position virtual buttons, with either dedicated or programmable functionality for easy customization and assigning different applications. These virtual buttons are marginally outside the display area but still within the touch sensitive area. When a fixed virtual button is selected, it invokes an associated command on Display Pad or Computing Device associated with that virtual button.

The Display Pad may also contain “soft” buttons. These soft buttons are completely included in the pressure sensitive display touch area and are completely software driven.

The Display Pad provides multi-functionality in addition to the standard mouse function, some examples of functions that can be supported by the system include but are not limited to: Calculator, Currency Converter, Time and Date, World Clock, Screen Saver, SlideShow of your favorite Pictures, Alarm, Alerts, Day Calendar, Audible and Tactile response to selection, etc.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 shows the key components of the pressure sensitive display pad for controlling a consumer electronic device.

FIG. 2 shows a cross section of a pressure sensitive touch pad in a laptop.

FIG. 3 shows a pressure sensitive touch pad with mechanical keys and a keyboard with dedicated mechanical keys providing quick access to applications.

FIG. 4 shows a pressure sensitive touchpad with virtual programmable buttons within the touch sensitive area

FIG. 5 shows a pressure sensitive touch pad with display area and soft keys exposing sample utility applications which can be viewed in the touch sensitive display, Laptop display, or both.

FIG. 6 shows an alternative implementation of the assembly described in FIG. 1, with the display disconnected from touch lens.

FIG. 7 shows an alternative implementation of the assembly described in FIG. 1, with the display connected from touch lens.

FIG. 8 shows a space efficient implementation of the force sensors used in the assemblies described in FIGS. 1, 2, 6 and 7.

FIG. 9 illustrates how the active part of the piezo resistive force sensor, a piezo resistive pressure sensor 32 may be surface mounted on flex film or thin PCB 31 attached under the touch lens and display assembly 30.

### DETAILED DESCRIPTION OF THE PREFERRED EMBODIMENTS

The present invention is a pressure sensitive display pad separate and apart from the primary computer display and resident, for example, where a mouse pad would normally reside. The pressure sensitive display pad includes Virtual Programmable Applications Buttons for launching Utility Applications.

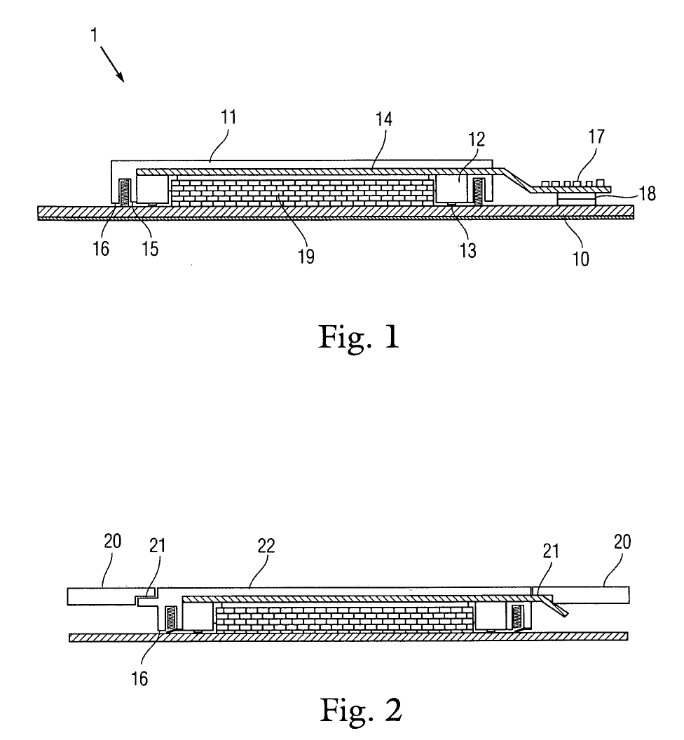

FIG. 1 describes the generic buildup of a pressure sensitive display pad 1 here adapted for operating a computing device. A transparent lens 11 is suspended overtop and serves to house all the required electronic and mechanical components. The lens 11 supports one or more flexfilm connectors 14 or wires that connect internal force sensors 12 with the specific electronic components 17 as well as the main logic of the computing device. A display 19 such as an LCD, OLED or other display resides under the touch sensitive lens 11 and is viewable up through the lens 11. The display may be structurally a part of the touch sensitive lens 11, or the lens may be suspended above the display. This assembly may be a peripheral connected to a computing device (such as a PC) by USB or other standard peripheral cable, or wirelessly, or may be panel-mounted on the computing device (such as in place of a standard mouse pad) and hardwired to the main CPU (typically using an SPI or I2C bus). In all such cases the assembly operates as a mouse device eliminating many of the current PC mouse limitations as referenced in the background section.

In this embodiment, the force sensors 12 are each a small package where an internal pressure sensor is seated atop a small metal ball 13 that hits an underlying surface 10, which could be a PCB, housing, or other mechanical component of the device. Thus, the balls 13 are pressed onto the pressure sensors 12 when pressure is applied on the lens assembly 11. Given four (4) corner mounted sensors 12 as illustrated, each sensor 12 registers a different force which can be readily combined to yield an exact coordinate representing where the touch is registered. In order to ensure that side forces, in the xy-plane are minimized or eliminated and that the touch pad system only register forces in the z-plane when the lens assembly 11 is touched, especially if sensitive pressure sensors 12 are used, the lens assembly 11 may be spring loaded with regular spiral springs 15 or other suspension mechanisms, such as illustrated in PCT application PCT/US200803374 filed on Mar. 14, 2008, which is integrated in the lens housing 11, or other spring system or cushioning such as rubber or foam.

The lens assembly may also have downwardly protruding stops 16 that contact the underlying surface before the pressure sensors 12 bottom out and possibly get damaged.

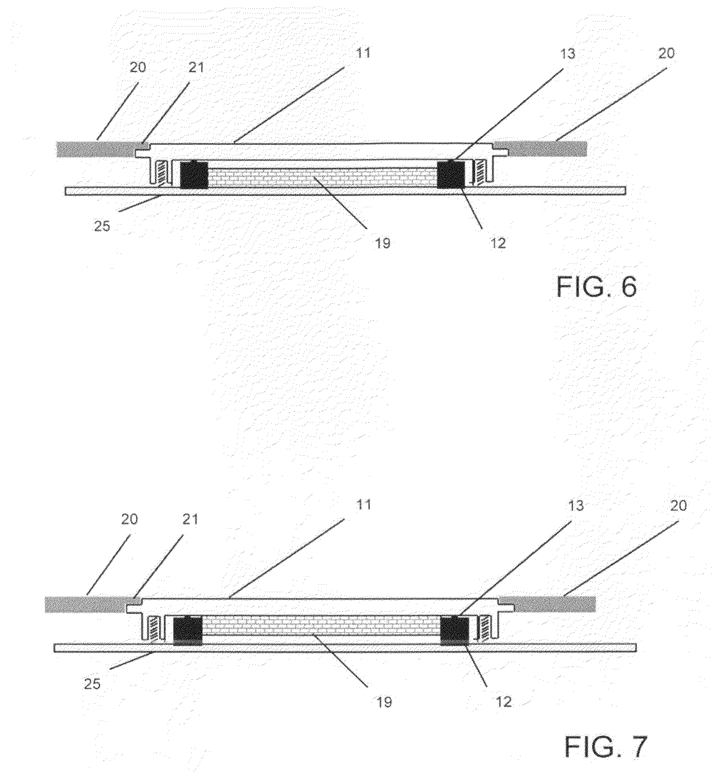

FIG. 6 and FIG. 7 are examples of how the same touch sensitive assembly described in FIG. 1 may also be constructed in an inverted manner, where the force sensors are mounted on flexfilm or PCB 25 and the touch sensitive lens 11 is resting on the force sensitive steel ball 13 of the sensor. In this implementation scenario, the display 19 may still be mounted directly onto the lens, as in FIG. 7, or onto the underlying PCB, as in FIG. 6.

The flexfilm 14 in the assembly 1 also serves as component surface for the assembly's specific electronic components 17. The display 19 will include its own flexfilm connector, and the flexfilm 14 and display 19 connectors may be combined as an integral flexfilm, providing all control lines as well as power supply to both the display 19 and the specific electronic components 17.

For size-constrained devices, it may be necessary to reduce the thickness of the complete solution. It may then be needed to use a thinner force sensor then the piezo resistive sensor used in the previous figures.

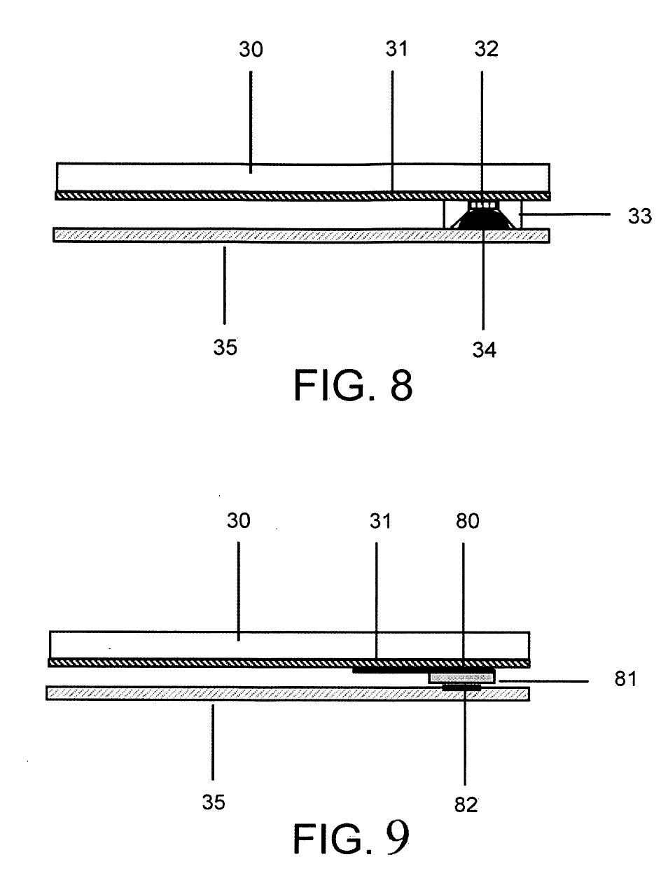

FIG. 8 illustrates how the active part of the piezo resistive force sensor, a piezo resistive pressure sensor 32 may be surface mounted on flex film or thin PCB 31 attached under the touch lens and display assembly 30. The underlying bottom housing 35 is equipped with a protruding surface 34 with a rounded shape which is in contact with the pressure sensor. Guiding walls are added to the bottom housing 35 or the touch lens 30 to ensure protection and correct alignment.

An alternative implementation is illustrated in FIG. 9, where the piezo resistive sensor is replaced by a force sensing resistor. This type of sensor has a lower accuracy, but can be made as thin as 0.5 mm. Here the conductive plates of the sensor 80 is connected to or designed as a part of the flexfilm 31 under the display/touch lens 30. An activator 82 may be added to the underlying housing to ensure a correct force transfer into the center of the resistive material 81 to the sensor 80.

Software is provided either in the electronic components 17 within the assembly 1, or in the computing device CPU that segregates specific areas on the lens 11 into discrete virtual programmable buttons for operating the computing device. Other areas of the lens 11 are reserved for traditional mouse pointing functions. This software comprises a memory-resident executable program to interpret the pressure data derived from four (4) corner mounted sensors 12, to calculate an exact (x,y) coordinate representing where the touch point was registered, and to analyze the (x,y) coordinate to determine whether it falls within any of the pre-designated areas assigned to discrete virtual programmable buttons. This way, the combined touch force of all the sensors 12 may yield a coordinate corresponding to a discrete virtual programmable button. The Display Pad 1 still performs the pointing and selection functions of existing laptop or other touchpads, but additionally provides for fixed or programmable pressure sensitive application functions using the virtual buttons, which can launch utility applications associated with specific buttons, either on the computer screen or on the Display Pad display or both. The software also allows programming of the parameters of applied force necessary to interpret the type of key press. These parameters may include a minimum pressure needed for interpretation as an actual key-press, or an incremental interpretation dependent on the pressure (such as the volume button, where a higher force may be construed as louder volume and vice versa, or a fast forward key where more pressure indicates faster forwarding through a song file.

If desired, the pressure sensors 12 may be equipped with optional feedback tactile and/or audible and/or visual upon accepted selection of a command. The virtual programmable buttons may be fixed in location and/or functionality, or may be fully programmable for application assignment flexibility or non-mechanical customization. Moreover, since the display 19 is fully visible to the user the virtual programmable buttons may be indicated on the display 19 and may be dynamic, providing aesthetics such as a screen saver or slideshow, entertainment with a game or video clip, or productivity with applications like a calculator, currency converter, or daily event calendar while at the same time operating as a mouse for pointer navigation and selection on the computing device. This effectively eliminated the need to leave the main computer application displayed on the laptop display, since the applications initiated from the virtual programmable buttons on the Display Pad 1 can be run on the primary computer display, the Display Pad display 19, or both.

FIG. 2 is a cross section of a pressure sensitive touch pad that shows how the display assembly can be housed inside the overall mechanical cover of, for example, a laptop computer. In this embodiment the lens 22 protrudes out under the mechanical housing 20 to secure the lens 22 in place. This prevents the lens 22 from falling out, but allows it to be free to move up and down for the required distance to allow for accurate force loading of the force sensors 12, which is approximately 0.1 mm. The area between the mechanical housing 20 and the lens 22 would typically hold a rubber strip 21 to both limit the movement of the display as well as to buffer it and insulate the device from dirt and dust. The movement required from O-pressure-applied to maximum-pressure-applied (or maximum allowed movement), as allowed by the lens stopper 16, is typically not more than 0.1 mm.

Another advantage by using the pressure sensitive lens assembly 1 is that since it has to allow for a small movement and therefore will not be a fixed part of the mechanical housing, it can be made to vibrate independent of the mechanical housing, and therefore provide a very effective and accurate tactile feedback to the end-user.

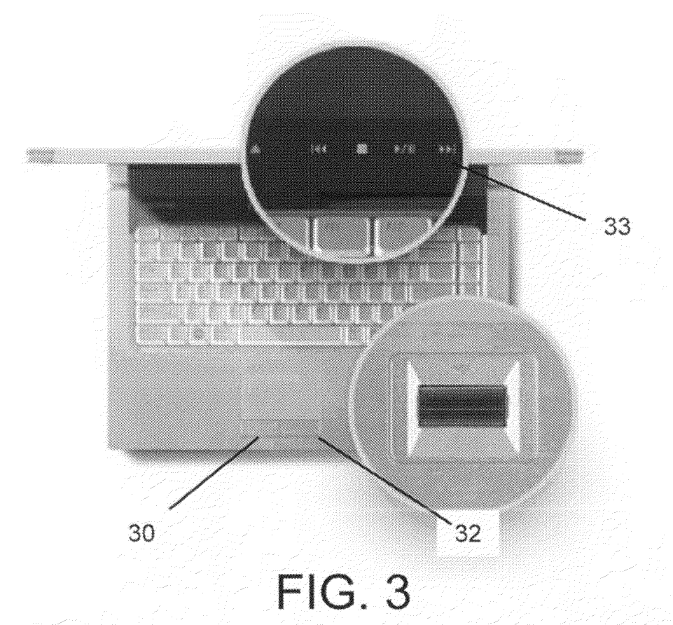

FIG. 3 is a top view of capacitive laptop touchpad with fixed mechanical buttons 30, 32 to assist in pointing, evoking an action, and menu option selection process. The touchpad is used to drive the laptop pointer. The left mechanical button 30 is used to select an action and the right mechanical button 32 is used to enable a menu exposing a number of edit functions. Additional mechanical buttons 33 may be located on the laptop keypad area shown above the QWERTY keypad. Dedicated buttons 33 are used for quick access to computer functions and launching applications. Combinations of mechanical keys also enable actions for computer functions.

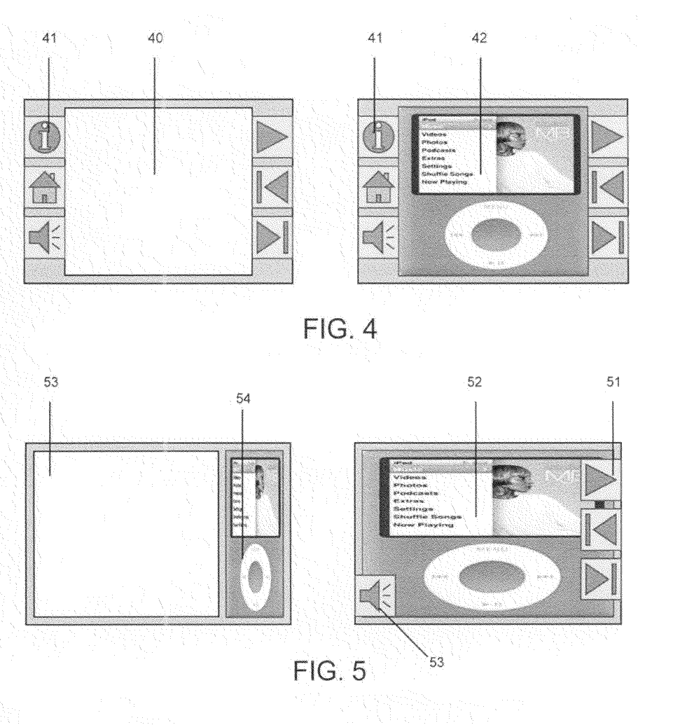

FIG. 4 illustrates a top view of a pressure sensitive display pad with virtual buttons as described above. In this case, there is a marginal area on the display pad dedicated to evoking a predetermined command set via virtual buttons 41, and a central area for selecting and moving the pointer 40. The respective areas can be painted or stamped to indicate that they are dedicated to the corresponding functions. The virtual buttons may be made generic and provide different type of commands for different types of applications, but in this embodiment, the button icons are fixed. An alternative implementation is to incorporate a display underneath the touch sensitive area 42. The display may display applications, information and commands. The display area may also display input keys, such as in the FIG. 4 where a touch sensitive “iPod wheel” is displayed, but may also display soft keys information for the permanent keys 41. Note that the complete surface area covering the underlying display 42 and the printed keys 41 is one and the same touch sensitive area.

FIG. 5 describes a top view of a 2 additional implementation options for a pressure sensitive display pad with multi-functionality. The first view represents a touch pad implementation with a larger touch sensitive area 53 and a smaller display implemented next to it 54 with the purpose of displaying multiple keys/buttons appropriate to the application/applications currently running. Alternatively, a larger display may be used that covers the complete touch sensitive area 52. This display may display applications and images, information, commands as well as soft keys and buttons 51 depending on the application/applications currently running.

Multiple use cases can be supported with this dynamic touch pad construct, for example, when a virtual button or “soft” button evoking an application is selected, the application takes over the touch sensitive area in the case of a virtual button implementation and the entire area in the case of no or soft buttons implementation. The application runs until it is complete and then the touch sensitive functionality state returns to the display pad device. An array of sample utility applications are shown at right including Clock, Day Schedule, World Times, Calculator, Weather, Currency Converter, and Picture Gallery. These sample utility applications can be viewed in the touch sensitive display, Laptop display, or both.

It should now be apparent that the above-described Display Pad with Virtual Programmable Applications Buttons reduces or eliminates the need for mechanical buttons, while providing instant access to productivity applications such as a calculator, currency converter, daily event calendar, etc., and improves computing aesthetics with screen savers or slideshows, entertainment, etc. Still the device affords full navigation functionality such as operating as a mouse for pointer navigation and selection on the computing device.

It should also be apparent that since the touch pad described here is based on pressure sensing, the applications may also use the level of applied force for controlling input. For example, if the user presses the volume key 53 harder the volume will increase, and if the user presses it again, but with a lower force, the volume will decrease.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed is:

1. A touch-sensitive display panel having a first area comprising an array of discrete virtual programmable buttons for operating a computing device, and a second area comprising a touch pad for traditional mouse pointing functions.

2. The touch-sensitive display panel according to claim 1, wherein said discrete virtual programmable buttons include tactile, visual and/or audible feedback.

3. The touch-sensitive display panel according to claim 1, wherein said second area is dedicated to said touch pad and said first area comprises a plurality of fixed-position programmable-function buttons.

4. The touch-sensitive display panel according to claim 1, wherein said second area is dedicated to said touch pad and said first area comprises a plurality of programmable-position programmable-function buttons.

5. The touch-sensitive display panel according to claim 1, wherein said second area is dedicated to said touch pad and said first area comprises a plurality of fixed-position programmable-function buttons and a plurality of programmable-position programmable-function buttons.

6. In a computing device having a primary display and keyboard, a user input device comprising a touch-sensitive display panel separate from said primary display and defined by a pressure sensitive area segregated into a first area including an array of discrete virtual programmable buttons for operating said computing device, and a second area comprising a touch pad for controlling mouse pointing functions.

7. The user input device according to claim 6, wherein said virtual buttons on the pressure sensitive area each launch a corresponding software utility application.

8. The user input device according to claim 6, wherein said virtual buttons on the pressure sensitive area are fixed in position.

9. The user input device according to claim 6, wherein said virtual buttons on the pressure sensitive area have a user-defined position.

10. The user input device according to claim 8, wherein said virtual buttons on the pressure sensitive area each launch a corresponding software utility application from among a group comprising a Calculator, Currency Converter, Time and Date, Weather, World Clock, Screen Saver, SlideShow, Alarm, Alerts, Day Calendar.

11. The user input device according to claim 6, wherein said touch-sensitive display panel further comprises a transparent lens overtop a an electronic display, and a plurality of force sensors in contact with one of said transparent lens or electronic display for registering touch pressure there against.

12. The user input device according to claim 11, wherein said plurality of pressure sensors further comprise four corner-mounted pressure sensors for determining a two-dimensional coordinate location of a touch.

13. The user input device according to claim 12, further comprising software for determining when a two-dimensional coordinate location of a touch falls within the predetermined pressure sensitive area of one of said virtual buttons, and if so for launching said corresponding software utility application.

14. The user input device according to claim 6, connected remotely to said computing device by a peripheral cable.

15. The user input device according to claim 6, connected remotely to said computing device by a wireless connection.

16. The user input device according to claim 6, wherein said discrete virtual programmable buttons provide tactile feedback when touched.

17. The user input device according to claim 6, wherein said discrete virtual programmable buttons provide audible feedback when touched.

18. The user input device according to claim 13, wherein said software comprises a memory-resident executable program that interprets touch pressure data derived from said four corner mounted sensors and calculates an exact x,y coordinate representing where the a touch point was registered.

19. The user input device according to claim 14, wherein said software analyzes the x,y coordinate to determine whether it falls within any of the pre-designated areas assigned to said discrete virtual programmable buttons.

20. The user input device according to claim 18, wherein said memory-resident executable program interprets touch pressure data derived from said four corner mounted sensors and interprets a type of key press based on amount of applied force to a touch point.

21. The user input device according to claim 20, wherein said type of key press comprises incremental volume.

22. The user input device according to claim 20, wherein said type of key press comprises fast forward.
